(19) United States
(12) Patent Application Publication
(10) Pub. No.: US 2026/0323281 A1
(43) Pub. Date: Oct. 15, 2026

(54) REGISTRATION HANDLING OF LEDGER-BASED IDENTITY

(71) Applicant: Lenovo (Singapore) Pte. Limited, Singapore (SG)

(72) Inventor: Sheeba Backia Mary Baskaran, Friedrichsdorf (DE)

(73) Assignee: Lenovo (Singapore) Pte. Limited, Singapore (SG)

(21) Appl. No.: 19/111,162

(22) PCT Filed: Sep. 18, 2023
(86) PCT No.: PCT/IB2023/059240

§ 371 Date: Mar. 12, 2025

Related U.S. Application Data
(60) Provisional application No. 63/408,627, filed on Sep. 21, 2022.
(60) Provisional application No. 63/408,639, filed on Sep. 21, 2022.
(60) Provisional application No. 63/408,645, filed on Sep. 21, 2022.

(51) Int. Cl. H04W 12/06; H04W 68/00

(52) U.S. Cl. CPC H04W 12/06; H04W 68/00

(57) ABSTRACT

Various aspects of the present disclosure relate to an apparatus, such as a network device, that receives a first signaling as a registration request from an end device, and generates a registry notification message based on successful authentication of the end device. The apparatus transmits a second signaling as a registry transaction notification to a first network entity that implements a permissioned distributed ledger (PDL). The apparatus receives a third signaling as a registration acknowledgement message from a second network entity that implements a registry service, and transmits a fourth signaling as a registration response to the end device.

### RELATED APPLICATIONS

This application claims priority to U.S. Provisional Application Ser. No. 63/408,639 filed Sep. 21, 2022 entitled “Registration Handling of Ledger-Based Identity,” the disclosure of which is incorporated by reference herein in its entirety. This application also claims priority to U.S. Provisional Application Ser. No. 63/408,627 filed Sep. 21, 2022 entitled “Digital Identity Management,” the disclosure of which is incorporated by reference herein in its entirety. This application also claims priority to U.S. Provisional Application Ser. No. 63/408,645 filed Sep. 21, 2022 entitled “Decentralized Identity Authentication and Authorization,” the disclosure of which is incorporated by reference herein in its entirety.

### TECHNICAL FIELD

The present disclosure relates to wireless communications, and more specifically to ledger-based identity handling.

### BACKGROUND

A wireless communications system may include one or multiple network communication devices, such as base stations, which may be otherwise known as an eNodeB (eNB), a next-generation NodeB (gNB), or other suitable terminology. Each of the network communication devices, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a communications system, digital identity management related to decentralized identifiers (DID) and self-sovereign identities (SSI) involves various processes, such as storage, management, handling, and verification of identities and relevant documents (e.g., verifiable credentials (VC), cryptography related information, etc.), as well as selective data disclosure in a distributed platform (e.g., permissioned distributed ledger(s)) to enable digital identity-based authentication and authorization. Further, digital identity management in a communications system can involve multiple network entities, such as an identity holder, a DID controller, a VC issuer, and/or relying party (e.g., verifier), to name a few.

### SUMMARY

The present disclosure relates to methods, apparatuses, and systems that support registration handling of ledger-based identity. By utilizing the described techniques, role-based registration is implemented for participants (e.g., end devices or device applications) that interact and are involved with an identity and trust management framework to enable a DID-based authentication and authorization of DID holders (i.e., a subject, or end-user). The described techniques also implement de-registration and/or revocation of registered participants who interact and are involved in the identity and trust management framework.

Aspects of the disclosure are directed to new permissioned distributed ledger (PDL) services and associated message exchanges and operations. In one or more implementations, the PDL services include a role-based registration management service; a participants registry service (also referred to herein as a DID operation participants registry service or as a ledger-identity and trust management participant registry service); a DID registry and DID resolver service; a DID document registry service, such as to create and store, update, and/or delete and revoke; a verifiable credentials data registry service, such as to create and store, update, and/or delete and revoke; and a DID verification service. The described role-based registration and de-registration services provide for and support decentralized identity management and related verification for end-devices and/or device applications.

In some implementations of the method and apparatuses described herein, a network entity (e.g., an apparatus, network device) implements a ledger registration management service (L-RMS). The L-RMS receives a registration request from an end device, and generates a registry notification message based on successful authentication of the end device. The L-RMS transmits a registry transaction notification to a first network entity that implements a PDL. The L-RMS receives a registration acknowledgement message from a second network entity that implements a registry service, and transmits a registration response to the end device.

Some implementations of the method and apparatuses described herein may further include the registration request includes an indication of the end device as at least one of a source identity, service-type information, a DID, a required access role, or a requested access role. The registry notification message includes at least one of a L-RMS identifier, a source identifier, service type information, a registry service type, a registry service identifier, a registration identifier, a DID, authorization information, an authorized access role, or a lifetime expiration. The registration response can include an indication of a failure result based on an authentication failure, a requested access role cannot be accepted, or a local policy. Alternatively, the registration response includes an indication of a success result, a L-RMS identifier, service-type information, a registration identifier, an authorized access role, authorization information, or a lifetime expiration. The service-type information included in the registration response indicates a DID service offered by an identity and trust management framework. The L-RMS can set the registration identifier, set the authorization information, and assign the lifetime expiration for registration. The L-RMS generates the registry transaction notification based on an adaption transformation of the registry notification message.

The registration acknowledgement message is received from a DID operational participant registry service.

In some implementations of the method and apparatuses described herein, a network entity (e.g., an apparatus, end device) transmits a registration request to a first network entity that implements a L-RMS, which authenticates the apparatus, transmits a registry transaction notification to a PDL, and receives a registration acknowledgement message from a registry service. The end device also receives a registration response from the L-RMS.

Some implementations of the method and apparatuses described herein may further include the registration request includes an indication of the end device as at least one of a source identity, service-type information, a DID, a required access role, or a requested access role. The registration response includes an indication of a failure result based at least in part on an authentication failure, a requested access role cannot be accepted, or a local policy. The registration response includes at least one of an indication of a success result, a L-RMS identifier, service-type information, a registration identifier, an authorized access role, authorization information, or a lifetime expiration. The service-type information included in the registration response indicates a DID service offered by an identity and trust management framework.

In some implementations of the method and apparatuses described herein, a network entity (e.g., an apparatus, network device) implements a L-RMS. The L-RMS receives a registration revocation request associated with an end device, the registration revocation request received from a first network entity that implements a registry service. The L-RMS processes the registration revocation request based on a L-RMS identifier associated with the end device, and transmits a registration revocation acknowledgement notification to the registry service that records registration revocation.

Some implementations of the method and apparatuses described herein may further include the registration revocation acknowledgement notification is transmitted to a second network entity that implements a PDL, the registration revocation acknowledgement notification propagated through a PDL network to the registry service that records the registration revocation. The L-RMS transmits a registration revocation notification to the end device, and receives a registration revocation acknowledgement message from the end device. The registration revocation request includes a L-RMS identifier associated with a registration identifier of a DID operational participant registry transaction corresponding to the end device. The registration revocation request includes a L-RMS identifier, a source identity, a registry service type, a registry service identifier, a registration identifier, and/or an authorized access role and a cause value related to the registration revocation.

In some implementations of the method and apparatuses described herein, a network entity (e.g., an apparatus, network device) implements a registry service. The registry service receives a registry transaction notification from a PDL, the registry transaction notification generated by a L-RMS based on a registration request from an end device and successful authentication of the end device. The registry service records the registry transaction notification, and transmits a registration acknowledgement message to the L-RMS that communicates a registration response to the end device.

Some implementations of the method and apparatuses described herein may further include the registry transaction notification includes at least one of a L-RMS identifier, a source identifier, service-type information, a registry service type, a registry service identifier, a registration identifier, a DID, an authorized access role, authorization information, or a lifetime expiration. The registration acknowledgement message includes at least one of a L-RMS identifier, a source identifier, a registration identifier, a registry service type, a registry service identifier, or a success indication. The registry service maintains records of DID based identity system participants, and is identified as one of a DID operational participant registry service, or as a ledger-identity and trust management participant registry service. The registry service can also transmit a registration revocation request to the L-RMS, the registration revocation request associated with the end device and based on a determination to invoke registration revocation. The registry service receives a registry transaction revocation notification from the PDL, the registry transaction revocation notification routed from the L-RMS via the PDL. The registry service records the registry transaction revocation notification. The registry service receives a registration revocation acknowledgement notification from the L-RMS, and records the registration revocation acknowledgement notification.

### BRIEF DESCRIPTION OF THE DRAWINGS

FIG. 1 illustrates an example of a wireless communications system that supports registration handling of ledger-based identity in accordance with aspects of the present disclosure.

FIG. 2 illustrates an example of verifiable claim(s) generation and use related to identity authentication and verification, as related to registration handling of ledger-based identity in accordance with aspects of the present disclosure.

FIG. 3 illustrates an example of DID registry on distributed ledger and blockchain, as related to registration handling of ledger-based identity in accordance with aspects of the present disclosure.

FIG. 4 illustrates an example of the basic architectural elements for SSI, as related to registration handling of ledger-based identity in accordance with aspects of the present disclosure.

FIG. 5 illustrates an example of a PDL platform service-based identity and trust management framework, which supports registration handling of ledger-based identity in accordance with aspects of the present disclosure.

FIG. 6 illustrates an example diagram of a role based registration procedure, which supports registration handling of ledger-based identity in accordance with aspects of the present disclosure.

FIG. 7 illustrates an example diagram of a revocation and de-registration procedure for the role-based registration, which supports registration handling of ledger-based identity in accordance with aspects of the present disclosure.

FIGS. 8 and 9 illustrate an example of a block diagram of devices that supports registration handling of ledger-based identity in accordance with aspects of the present disclosure.

FIGS. 10 through 16 illustrate flowcharts of methods that support registration handling of ledger-based identity in accordance with aspects of the present disclosure.

### DETAILED DESCRIPTION

Digital identity management related to DID and SSI involves various processes, such as storage, management, handling, and verification of identities and relevant documents (e.g., VC, cryptography related information, etc.), as well as selective data disclosure in a distributed platform (e.g., permissioned distributed ledger(s)) to enable digital identity-based authentication and authorization. Further, digital identity management in a communications system can involve multiple network entities, such as an identity holder, a DID controller, a VC issuer, and/or relying party (e.g., verifier), to name a few. However, the existing PDL platform does not offer services to support digital identity, specific identity and trust management process, which involves storage, management, handling, verification and management of multiple actors (e.g., access control and authorization), selective data disclosure to a relying party, etc.

The PDL platform services related to registration, application registration, identity, and identity management is generally not sufficient to support the decentralized identity management and related verification process due to various limitations. For example, the current registration service and application registration service do not support a role-based access control and authorization setting for registration, which is essential to handle different parties and their corresponding operations for a decentralized identity and trust management framework. Further, the identity and identity management service do not allow an identity holder (e.g., an end-device or device application) to set an identifier for itself, and does not allow (e.g., as an identity controller) to set an identifier for another device or object that is associated with the identity holder. Further, the existing PDL services do not support selective data sharing specific to managed identifier(s).

Aspects of the disclosure are directed to new PDL platform services to support identity (i.e., DID and SSI based) and trust management solutions, which relies on a PDL and/or any ledger platform for associated message exchanges and operations. In one or more implementations, the PDL services include a role-based registration management service; a participants registry service (also referred to herein as a DID operation participants registry service or as a ledger-identity and trust management participant registry service); a DID registry and DID resolver service; a DID document registry service, such as to create and store, update, and/or delete and revoke; a verifiable credentials data registry service, such as to create and store, update, and/or delete and revoke; and a DID verification service. The described role-based registration and de-registration services provide for and support decentralized identity management and related verification for end-devices and/or device applications.

By utilizing the described techniques, role-based registration is implemented for participants (e.g., end devices or device applications) that interact and are involved with an identity and trust management framework to enable a DID-based authentication and authorization of DID holders (i.e., a subject, or end-user). The described techniques also implement de-registration and/or revocation of registered participants who interact and are involved in the identity and trust management framework.

Aspects of the present disclosure are described in the context of a wireless communications system. Aspects of the present disclosure are further illustrated and described with reference to device diagrams and flowcharts.

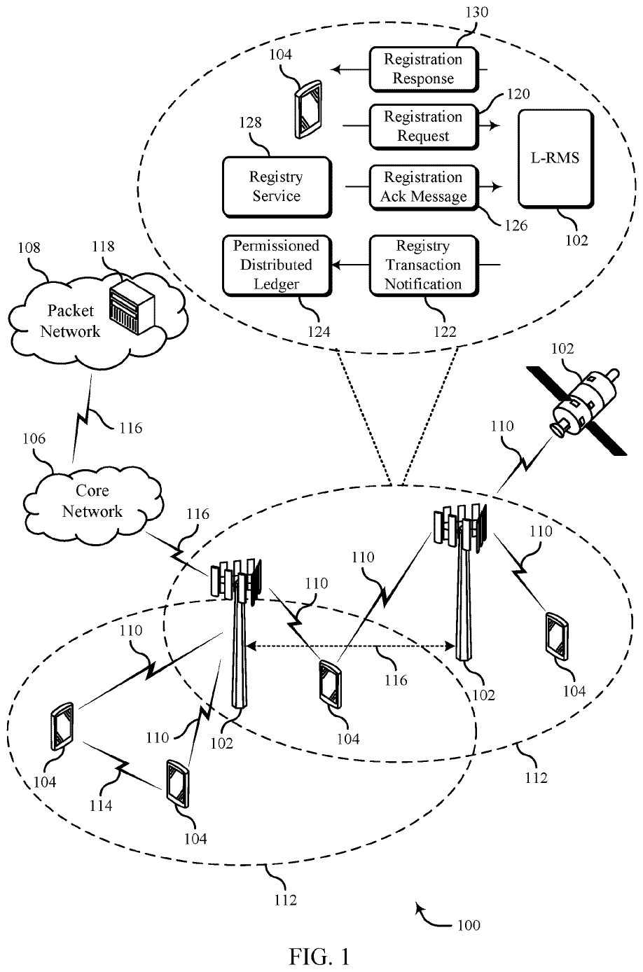

FIG. 1 illustrates an example of a wireless communications system 100 that supports registration handling of ledger-based identity in accordance with aspects of the present disclosure.

The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102.

The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., pμ0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHz-300 GHz). In some implementations, the network entities 102 and the UEs 104 may perform wireless communications over one or more of the operating frequency bands. In some implementations, FRI may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FRI may be associated with one or multiple numerologies (e.g., at least three numerologies). For example, FRI may be associated with a first numerology (e.g., μ=0), which includes 15 kHz subcarrier spacing; a second numerology (e.g., u=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 (e.g., an end device, or a device application) are operable to implement various aspects of registration handling of ledger-based identity, as described herein. For instance, a network entity 102 (e.g., an apparatus or device) implements a L-RMS that receives a registration request 120 from the UE 104 (e.g., an end device). The L-RMS generates a registry notification message based on successful authentication of the end device, and transmits a registry transaction notification 122 to a network entity that implements a PDL 124. The L-RMS receives a registration acknowledgement message 126 from a network entity that implements a registry service 128, and transmits a registration response 130 to the end device.

In aspects of registration handling of ledger-based identity, decentralized identity and/or SSI based identity management solutions are discussed in the context of trust framework created by the electronic IDentification, Authentication and trust Services (eIDAS) Regulation. According to the current DID specification of W3C, decentralized identifiers (DIDs) are a new type of identifier for verifiable, “self-sovereign” digital identity. DIDs are fully under the control of the DID subject, independent from any centralized registry, identity provider, or certificate authority. DIDs are URLs that relate a DID subject to means for trustable interactions with that subject. DIDs resolve to DID documents, which are simple documents that describe how to use that specific DID. Each DID document may contain at least proof purposes, verification methods, and service endpoints. The proof purposes are combined with verification methods to provide mechanisms for proving things. For example, a DID document can specify that a particular verification method, such as a cryptographic public key or pseudonymous biometric protocol, can be used to verify a proof that was created for the purpose of authentication.

Service endpoints enable trusted interactions with the DID controller. As DIDs are just an identifier, they do not provide information about the subject itself. In practice, DIDs are used in combination with verifiable claims to support digital interactions in which information about the subject is shared with third parties, by proving to those third parties that the DID subject has ownership of certain attestations or attributes. This proof is based on the cryptographic link between the verifiable claims, the DID subject the verifiable claims is about, and the issuer of the verifiable claims, which can be the own DID subject (self-asserted claims), or a trusted entity. Trust on the issuer is established either by trusting the issuer's DID (e.g. out-of-band, bilateral relationship, trusted lists) or by any other means. The third party can then use the presented cryptographically protected proof to verify the ownership and trustworthiness of the claims about the subject. As the presentation of the claims is managed totally by the users, they can decide on which specific pieces of information about themselves they want to share with third parties, by which selective disclosure of attributes privacy and personal data protection is reinforced.

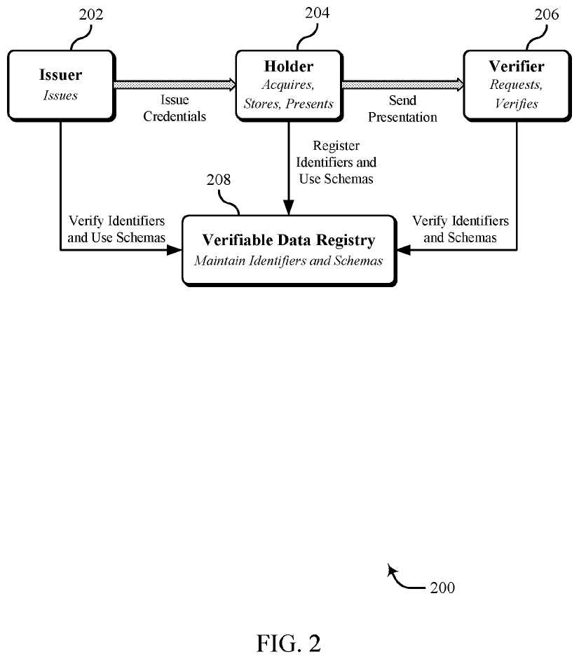

FIG. 2 illustrates an example 200 of verifiable claim(s) generation and use related to identity authentication and verification, as related to registration handling of ledger-based identity in accordance with aspects of the present disclosure. The flow of information of the verifiable claims generation and use, as shown in the example 200, is derived from the W 3C working draft of the verifiable credentials data model (1.0). In this data model, credentials are considered as a set of one or more claims made by an issuer 202 and may also include credential metadata and one or more proofs. In this example 200, the issuer 202 issues credentials to a holder 204 that acquires, stores, and presents the credentials. The holder 204 sends a presentation to a verifier 206 that requests and verifies. A verifiable data registry 208 receives input from the issuer 202, from the holder 204, and from the verifier 206, and the verifiable data registry 208 maintains identifiers and schemas.

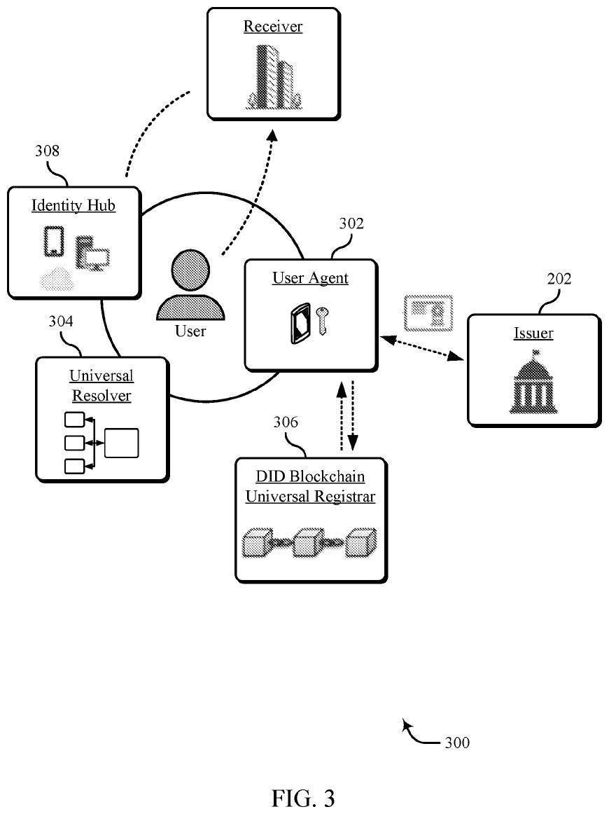

FIG. 3 illustrates an example 300 of DID registry on distributed ledger and blockchain, as related to registration handling of ledger-based identity in accordance with aspects of the present disclosure. To implement DID and VC, organizations working on SSI rely on the use of distributed ledgers and/or blockchains to support the registry of identifiers. In particular, the Decentralized Identity Foundation (DIF) proposes the architecture shown in the example 300, which includes several components. For example, a user agent 302 is a program, such as a browser, mobile application, or other web-based client, that mediates the communication between holders (204), issuers (202), and verifiers (206). A universal resolver 304 is a server featuring a pluggable system of DID method drivers that enables resolution and discovery of DIDs across any decentralized system. A universal registrar 306 is a server that enables the registration of DIDs across any decentralized system that produces a compatible driver. Additionally, an identity hub 308 is a secure personal datastore that coordinates storage of signed and/or encrypted data, and relays messages to identity-linked devices.

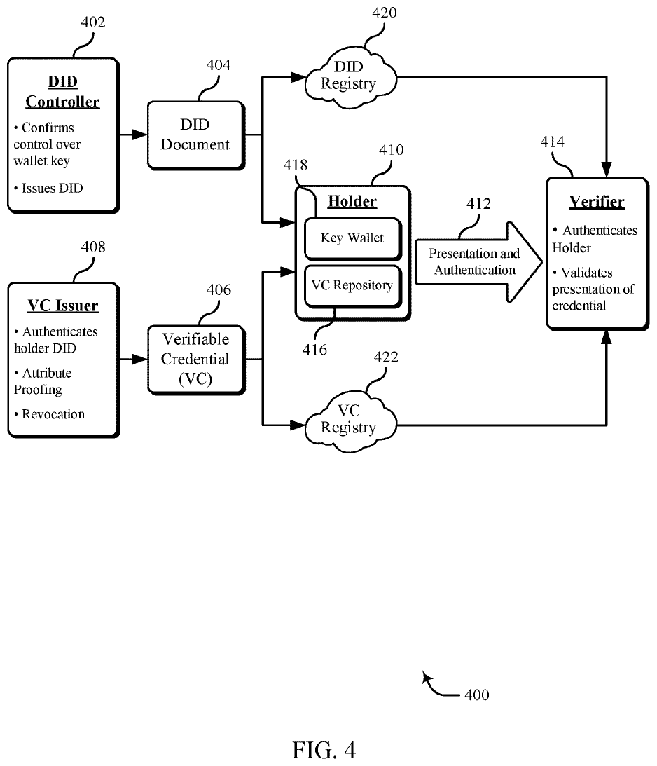

FIG. 4 illustrates an example 400 of the basic architectural elements for SSI, as related to registration handling of ledger-based identity in accordance with aspects of the present disclosure, such as related to the process of identity management and identity verification from the perspective of SSI. The basic architectural elements include a DID as a type of identifier that enables verifiable, decentralized digital identity. A DID refers to any subject (e.g., a person, organization, thing, data model, abstract entity, etc.) as determined by the DID controller 402 of the DID. Within the context of this report, only natural and legal persons are considered as subjects.

A DID may be considered as a form of pseudonym as used in eIDAS, as it is not directly linked to a formal identifier of a natural or legal person. A DID document 404 contains information associated with a DID, and typically expresses verification methods, such as cryptographic public keys, and services relevant to interactions with the holder. A DID document may be signed by a DID Controller. The DID controller 402 of a DID is the entity (person, organization, or autonomous software) that has the capability-as defined by a DID method-to make changes to a DID document. The following secure processes for the DID controller are identified by this report: proof of possession or control of the holder of its private key, and issuance of a unique DID to the holder.

A verifiable credential (VC) 406 is a set of one or more claims made by a VC issuer 408. A verifiable credential 406 is a tamper-evident credential that has authorship that can be cryptographically verified. The VC issuer 408 is a role that a network entity can perform by asserting claims about one or more subjects, creating a verifiable credential from these claims, and transmitting the verifiable credential to a holder 410. Secure processes for the DID controller 402 are identified by this report, including authentication of the holder as identified by its DID, proofing that the claimed attributes belong to the holder, and revocation of a holder's attributes. A presentation 412 is data derived from one or more verifiable credentials, issued by one or more issuers, that is shared with a specific verifier 414. A verifiable presentation 412 is a tamper evident presentation encoded in such a way that authorship of the data can be trusted after a process of cryptographic verification.

A VC repository 416 (of the holder 410) is a program, such as a storage vault or personal verifiable credential wallet, that stores and protects access to holders' verifiable credentials. The use of the VC repository 416 is restricted to the holder 410 or other authorized parties. A key wallet 418 (of the holder 410) is an application used to generate, manage, store, or use private and public keys. This may need to be protected by a specially protected “secure element” within the wallet, and the use of the keys is restricted to the holder. In this report, wallet is used to cover the repository of verifiable data (e.g., DID documents, verifiable credentials) and a key wallet 418. A wallet may be considered as a form of secure area (SA-application), and may be supported through use of an agent service that is remotely accessed from the user's device and controlled through use of multiple authentication factors.

The example basic architecture includes a DID registry 420 and a VC registry 422. In order to be resolvable to DID documents, DIDs are typically recorded on an underlying system or network of some kind. Regardless of the specific technology used, any such system can support recording DIDs and returning data necessary to produce DID documents. In this report, this is referred to as the DID registry 420 (or DID document registry). The DID registry can be based on a distributed ledger, such as blockchain. A system may perform a role by mediating the creation and verification of identifiers, keys, and other relevant data, such as verifiable credential schemas, revocation registries, issuer public keys, and so on, which can be required to use verifiable credentials. Some configurations might require correlating identifiers for subjects, and some registries, such as ones for UUIDs and public keys, can act just as namespaces for identifiers. A holder authentication provides the protocol exchange to obtain authorized access to a resource.

In an example implementation, the European Telecommunications Standards Institute (ETSI) PDL reference architecture describes services such as registration services, identity services and identity management services (among other services) as described below. With reference to registration: List a managed object with authorities or registries [clause 5.4.2.5 ETSI-ISG-PDL Registration Platform Service]. Registration services can provide means to list an ETSI-ISG-PDL managed object with local or international authorities or registries. Such registries allow reference to such managed objects for legal, commercial, and operational purposes. Registration requirements may vary with geography, though not all registries are linked to the geography in which they are used. Certain managed objects (e.g., a PDL serving a geographically diverse application) operate in multiple geographies and may require multiple registrations. An ETSI-ISG-PDL managed object may be registered in one or more registries. A registered ETSI-ISG-PDL managed object is to be registered in accordance with the regulations and rules applicable in the geographies in which it operates.

With reference to application registration: Registers and lists all applications operated on a platform. Accordingly [clause 5.4.3.21.6 Application Registration], application registration is a functionality that registers and lists all applications operated on a platform. An ETSI-ISG-PDL platform is to maintain a list of all applications registered and operated on it.

With reference to identity: Unambiguously identifies an instance of an entity from other instances of this and other objects. Accordingly [clause 5.4.2.3 ETSI-ISG-PDL Identity Platform Service] the identity of an entity is a set of context-dependent digital identifiers that unambiguously identify an instance of that entity from all other instances of this and other objects. An identity may use multiple attributes to uniquely identify it (e.g., two products with the same name have other different attributes, such as different serial numbers).

An ETSI-ISG-PDL identity is to be constructed using one or more context-dependent digital identifiers that enable an object instance to be unambiguously identified. A digital identifier is a secure object that is unique within a particular namespace. It is recommended that every digital identifier is assigned a namespace. An ETSI-ISG-PDL digital identifier can be defined within a namespace to guarantee its uniqueness. An entity may be used in different situations. Therefore, the same entity may be identified using a different set of digital identifiers for each situation. This enables the semantics of the use of an entity in each situation to be taken into account.

An ETSI-ISG-PDL managed object may have multiple context-dependent digital identifiers for establishing the identity of the managed object in different situations in which it is used. An ETSI-ISG-PDL identity service provides a single identity token per instance of an entity for all services so that this instance is identified unambiguously and in the same manner by all services. An ETSI-ISG-PDL identity service is to provide a single digital identity token per instance of an entity.

With reference to identity management: Access control based on the identity of an entity. Accordingly [clause 5.4.3.4.6 ETSI-ISG-PDL Identity Management Platform], service identity management defines access control based on the identity of an entity that initiates a particular set of operations on a target according to a set of criteria. The ETSI-ISG-PDL identity management platform service depends on the ETSI-ISG-PDL namespace platform service and the ETSI-ISG-PDL identity platform service. An identity-management platform service is to be implemented in all ETSI-ISG-PDL compliant platforms. The identity management platform service and the identity platform service can be two distinct and different services. The identity platform service defines how identities are assigned, while the identity management platform service defines how access is managed based on an assigned identity.

In aspects of registration handling of ledger-based identity, new PDL platform services can be implemented to support identity (i.e., DID and SSI based) and trust management solutions, which relies on a PDL and/or any ledger platform for associated message exchanges and operations. In one or more implementations, the PDL services include a role-based registration management service; a participants registry service (also referred to herein as a DID operation participants registry service or as a ledger-identity and trust management participant registry service); a DID registry and DID resolver service; a DID document registry service, such as to create and store, update, and/or delete and revoke; a verifiable credentials data registry service, such as to create and store, update, and/or delete and revoke; and a DID verification service. The described role-based registration and de-registration services provide for and support decentralized identity management and related verification for end-devices and/or device applications.

By utilizing the described techniques, role-based registration is implemented for participants (e.g., end devices or device applications) that interact and are involved with an identity and trust management framework to enable a DID-based authentication and authorization of DID holders (i.e., a subject, or end-user). The described techniques also implement de-registration and/or revocation of registered participants who interact and are involved in the identity and trust management framework.

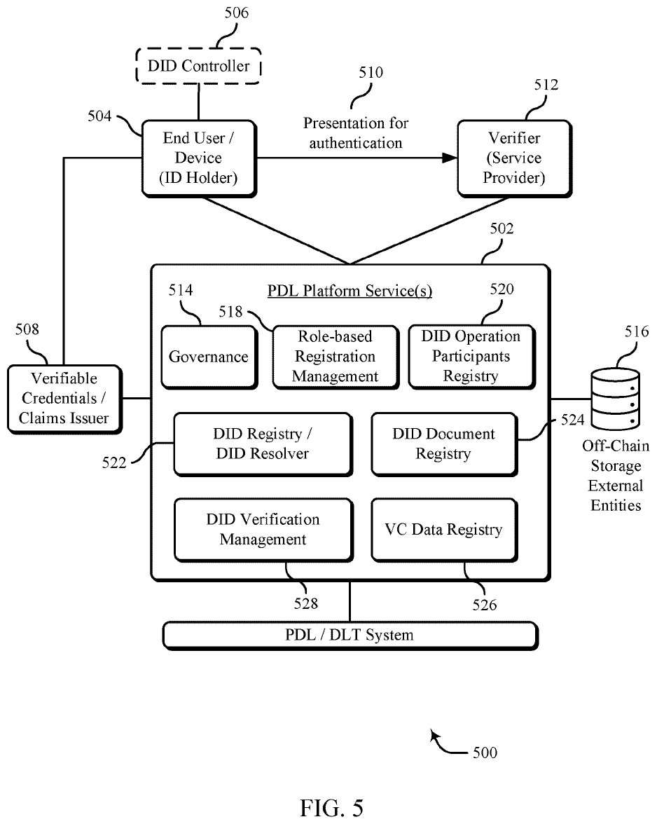

FIG. 5 illustrates an example 500 of a PDL platform service-based identity and trust management framework, which supports registration handling of ledger-based identity in accordance with aspects of the present disclosure. With reference to registering a DID operation (i.e., DID and/or SSI based identity and trust management) participants to a PDL platform, new PDL platform services 502 are implemented, such as a role-based registration management service and a DID operational participants registry service. The DID and/or SSI based identity and trust management solution described in this example covers the role-based registration for various actors or participants involved in the PDL platform-based identity and trust management framework, such as shown in the example 500.

An end user or device is an identity holder 504 (e.g., referred to as the subject, such as a person, organization, thing, data model, abstract entity, function, end-user, device, etc.). The identity holder 504 can generate a digital identifier, such as decentralized identifier (DID) or self-sovereign identifier (SSI), either by itself or the digital identifier can be generated and provisioned to the identity holder 504 by the service provider or a DID controller 506 (i.e., another party or entity that creates the digital identifier on behalf of the identity holder to identify and authenticate the identity holder). Examples include, an organization can be an identity controller for its employees who are the identity holders, and a person can be the identity controller for an Internet-of-things (IOT) object associated to a person, where the IoT object can be the identity holder, etc.

A verifiable credentials and/or claims issuer 508 (VC Issuer) can perform asserting claims about one or more subjects, creating a verifiable credentials (VCs) from these claims (e.g., passport, driving license, and birth certificate), and transmitting the VC to a holder, where the VC includes a set of one or more claims made by an issuer. A verifiable credential is a tamper-evident credential that has authorship, which can be cryptographically verified. The identity holder 504 presents the data (i.e., for authentication and authorization) derived from one or more verifiable credentials, issued by one or more issuers, that is shared as a presentation for authentication 510 with a specific verifier 512. A verifiable presentation is a tamper evident presentation encoded in such a way that authorship of the data can be trusted after a process of cryptographic verification.

To enable any verifier (such as a service provider or third-party service provider) to verify the DID and authenticate the identity holder and/or subject, this example 500 implements the new PDL platform services 502 (in addition to the existing PDL services) related to role-based registration, storage and management of DIDs, DID documents, VCs, verification of DIDs, and selected exposure of data and/or claims (as required for the service). Further the DID based identity framework may also include services related to governance 514 (i.e., governance platform services can be a collection of rules and tools that control the behavior and function of a PDL platform to enable identity and trust management) and off-chain storage 516 (i.e., storing of information in a digital, machine-readable medium that is not stored on the main chain) to enable scaling of blockchain-based applications that are data-intensive and/or data sensitive, such as VCs. It is often used to store non-transactional data that is too large to be stored in the blockchain efficiently, or requires the ability to be changed or deleted. The off-chain data is typically only accessible by a subset of the nodes participating in a chain.

The PDL platform services 502 include a role-based registration management service 518 (i.e., operation may involve registration, revoke, and/or de-registration). The role-based registration management service accounts for different roles, actors, and/or participants to be involved in the identity and trust management framework, and provides a registration service (along with authorization) specific to the corresponding roles of the actors in the PDL platform. The different roles include an identity holder, an identity controller, a VC issuer, an ID verifier, etc. to include (e.g., any participant or stakeholder to be involved in the identity and trust management framework).

The PDL platform services 502 also include a DID operation participants registry service 520. The DID operation(al) participants registry service records and keeps track of the registered and de-registered identity and trust management framework participants in the PDL platform based on instructions from the role-based registration management service 518. The PDL platform services 502 also include a DID registry and/or DID resolver service 522, which stores and keeps track of the DID(s) and its associated DID document location information (e.g., address) to enable DID document fetching and verification by the authorized services and entities.

The PDL platform services 502 also include a DID document registry service 524 (i.e., an operation may involve create and store, update, and delete and revoke DID documents). The DID document registry service 524 can store and manage the DID documents associated to the DID to facilitate DID verification. Each DID Document can contain at least proof purposes, service specific information for which the DID document can be used, verification methods, and service endpoints. Proof purposes are combined with verification methods to provide mechanisms for proving things. For example, a DID document can specify that a particular verification method, such as a cryptographic public key or pseudonymous biometric protocol, can be used to verify a proof that was created for the purpose of authentication. Service endpoints enable trusted interactions with the DID controller 506, as well as with an authorized verifier.

The PDL platform services 502 also include a verifiable credentials (VC) data registry service 526 (i.e., an operation may involve create and store, update, and delete and revoke VCs). The VC registry service 522 can store and manage the VCs associated to the DID to facilitate VC based DID verification and validation related to a service request. The PDL platform services 502 also include a DID verification management service 528. The DID verification management service can be implemented as a composite service that uses the DID registry service and/or DID resolver service 522, the DID document registry service 524, and the DID operation(al) participant registry service 520 to fetch necessary data related to verification of DID (i.e., authentication of the subject identified by the DID), and exposure of selective data to the verifier 512 to enable authorization verification of a subject to respective service(s).

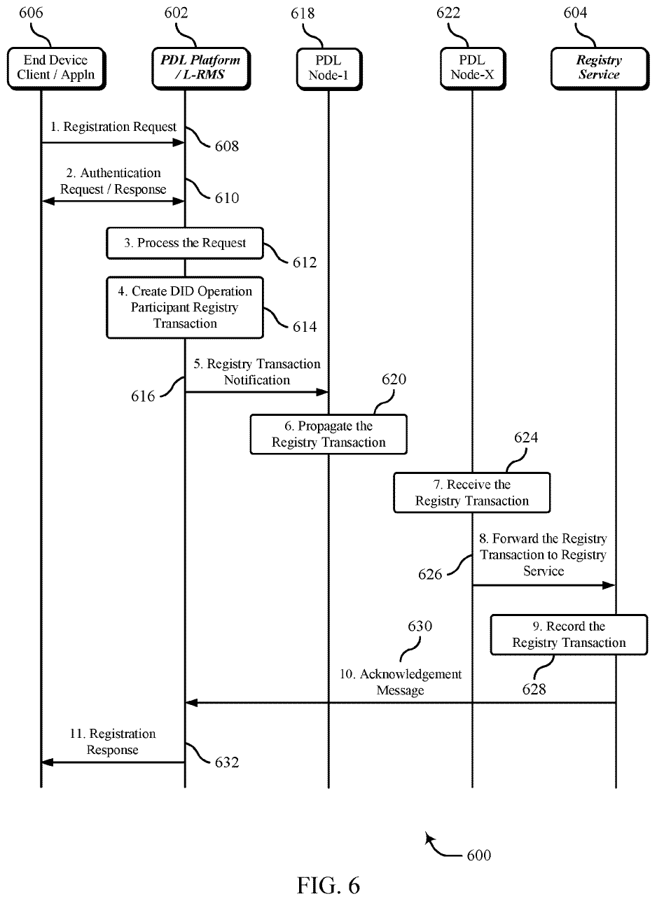

FIG. 6 illustrates an example diagram 600 of a role based registration procedure, which supports registration handling of ledger-based identity in accordance with aspects of the present disclosure. The role-based registration procedure involving a role-based registration management service 602 and a DID operation(al) participants registry service 604 is shown in the example diagram 600. As a precondition, an end device 606 (i.e., an ID holder) may have registered to the PDL platform as a general user of the PDL platform, in which case the ID holder may have a source identity. If the ID holder does not have a previous general registration with the PDL platform, the ID holder may send anonymous or any preconfigured identity in the source identity.

At a first step 608, the ID holder (e.g., end device 606, device application) sends (e.g., communicates, transmits) to the PDL platform and L-RMS a registration request, which can include a source identity, service type information (i.e., as DID service, to indicate that the registration is related to the DID end-device to act as the DID based ID holder or user in the identity management framework), an access role that indicates the end-user or ID holder role is requested, and the DID (i.e., a digital identity based on DID or SSI generated for the ID holder either by the subject or by the service provider, and provisioned to the ID holder and is provided as part of the DID). Alternatively, the source identity may include the DID to be registered for the ID holder in the PDL platform. Alternatively, the registration request can be termed as DID registration request.

At a second step 610, the L-RMS may initiate and perform mutual authentication communications (e.g., based on local policy) with the ID holder based on any preconfigured credentials (e.g., certificates or public-private key pair or any secret key). At a third step 612, if a mutual authentication is performed and if it is successful, the L-RMS processes the registration request.

At a fourth step 614, the L-RMS determines to register the ID holder, and generates or sets a registration ID for the ID holder. Further the L-RMS generates a registry transaction notification message which includes the L-RMS ID, target registry service information (i.e., such as registry service name, an ID or address related to the DID operation(al) participant registry), a source identity, service type information (DID service), a registration ID, DID, an authorized access role (set as ID holder), an authorization code, and a lifetime expiration (e.g., for the validity of the registration). Further, the message can be transformed into a transaction (i.e., DID operation(al) participant registry transaction) to add the new participant to the registry (i.e., called as DID operation(al) participant registry). Alternatively, the L-RMS can directly generate the DID operation(al) participant registry transaction, which can include L-RMS ID, target registry service information (i.e., such as a registry service name, an ID or address related to the DID operation(al) participant registry), a source identity, service type information (DID service), a registration ID, DID, an authorized access role (set as ID holder), an authorization code, and a lifetime expiration (e.g., for the validity of the registration).

At a fifth step 616, the L-RMS sends (e.g., communicates, transmits) to a configured PDL node 618 a DID operation(al) participant registry transaction, which includes the registry transaction notification message. Notably or alternatively, the DID operation(al) participant registry service can be termed as a ledger-identity and trust management participant registry service. Alternatively, the target registry service information can be part of the DID operation(al) participant registry transaction, in which case the L-RMS at the fourth step 614 sends the generated PDL transaction (i.e., DID operation(al) participant registry transaction) to the PDL node 1 618 (based on local configuration).

At a sixth step 620, the PDL node-1 propagates the received registry transaction through the target PDL network (e.g., to any PDL node-X 622). At a seventh step 624, the PDL node-X 622 (e.g., any PDL Node-2) receives the transaction from the target PDL network as the result of transaction propagation.

At an eighth step 626, after the transaction is validated and it is successfully stored to the ledger (e.g., as a result of PDL consensus process in a ledger related to the registry service associated to the DID operation(al) participant registry (transaction) based on the target registry service type information), the PDL node-2 forwards the transaction to the registry service based on the target registry service information. The registry service transforms the transaction into a message to recover the message (i.e., the DID operation(al) participant registry transaction as a registry transaction notification message). Alternatively, the PDL node-2 transforms the transaction into message and sends the DID operation(al) participant registry transaction as a registry transaction notification message to the registry service.

At a ninth step 628, the registry service may store the DID operation(al) participant registry transaction and/or information received as part of the registry transaction notification message (or vice versa) in the local storage, off-chain, and/or ledger. At a tenth step 630, the registry service can send (e.g., communicate, transmit) to L-RMS, an acknowledgement message which can include the L-RMS ID, a source ID, a registration ID, a registry service type and/or ID, and the result as a success indication. Alternatively, the registry service may send a response (i.e., an acknowledgement message) to the L-RMS via PDL node-2 as a confirmation to the eighth step 626. At an eleventh step 632, the L-RMS sends (e.g., communicates, transmits) to the end device 606 a registration response L-RMS ID, service type information (DID service), a registration ID, an authorized access role, authorization information (e.g., a code or token), and a lifetime expiration.

With reference to adaptations for the identity (i.e., DID) controller registration, the message procedure flow shown in the example diagram 600 can be used for the identity controller registration to the identity and trust management framework of the PDL platform, and the described steps provided in the example diagram 600 can be applicable with the following adaption specific to the identity controller (instead of to the ID holder/subject). At the first step 608, the DID controller sends to the PDL platform and L-RMS, a registration request where the required access role is set as ‘ID/DID Controller’, and a source identity of the DID controller and the ID holder's source ID is also included with the other information as described for the first step above. The described second and third steps are performed the same as described above.

At the fourth step 614, the L-RMS determines to register the DID controller, and generates or sets a registration ID for the DID controller. Further the L-RMS creates a registry transaction notification message, which includes the L-RMS ID, target registry service information (i.e., such as a registry service name, an ID or address related to the DID operation(al) participant registry), a source identity of the DID controller, the ID holder's source ID, service type information (DID service), a registration ID, DID, an authorized access role (set as DID controller), an authorization code, and a lifetime expiration (for the validity of the registration). Further the message can be transformed into a transaction (i.e., DID operation(al) participant registry transaction) to add the new participant to the registry (i.e., called as DID operation(al) participant registry). The described fifth through eleven (5-11) steps are performed the same as described above.

With reference to adaptations for the VC issuer registration, the message procedure flow shown in the example diagram 600 can be used for the VC issuer registration to the identity and trust management framework of the PDL platform, and the described steps provided in the example diagram 600 can be applicable with the following adaption specific to the VC issuer (instead of the ID holder or subject). At the first step 608, the VC issuer sends to the PDL platform and L-RMS a registration request, where the required access role is set as ‘VC Issuer’, and a source identity of the VC issuer and the ID holder's source ID is also included with the other information as described for the first step above. The described second and third steps are performed the same as described above.

At the fourth step 614, the L-RMS determines to register the VC issuer and generates or sets a registration ID for the VC issuer. Further the L-RMS generates a registry transaction notification message, which includes the L-RMS ID, target registry service information (i.e., such as a registry service name, an ID or address related to the DID operation(al) participant registry), a source identity of the VC issuer, the ID holder's source ID, service type information (DID service), a registration ID, DID, an authorized access role (set as VC issuer), an authorization code, and a lifetime expiration (for the validity of the registration). Further the message can be transformed into a transaction (i.e., DID operation(al) participant registry transaction) to add the new participant to the registry (i.e., called as DID operation(al) participant registry). The described fifth through eleven (5-11) steps are performed the same as described above.

With reference to adaptations for the identity (i.e., DID) verifier registration, the message procedure flow shown in the example diagram 600 can be used for the DID verifier registration to the identity and trust management framework of the PDL platform, and the described steps provided in the example diagram 600 can be applicable with the following adaption specific to the DID verifier (instead of the ID holder or subject). At the first step 608, the DID verifier sends to the PDL platform and L-RMS a registration request, where the required access role is set as, ‘DID Verifier’, and a source identity of the DID verifier is also included with the other information as described for the first step above. The described second and third steps are performed the same as described above.

At the fourth step 614, the L-RMS determines to register the DID verifier, and generates or sets a registration ID for the DID verifier. Further, the L-RMS generates a registry transaction notification message, which includes the L-RMS ID, target registry service information (i.e., such as a registry service name, an ID or address related to the DID operation(al) participant registry), a source identity of the DID verifier, service type information (DID service), a registration ID, DID, an authorized access role (set as DID verifier), an authorization code, and a lifetime expiration (for the validity of the registration). Further the message can be transformed into a transaction (i.e., DID operation(al) participant registry transaction) to add the new participant to the registry (i.e., called as DID operation(al) participant registry). The described fifth through eleven (5-11) steps are performed the same as described above.

The L-RMS may accept the required access role provided by the end-device, client, or device application (in the first step) based on the authentication results (e.g., based on an end-user's information in the certificate or any service level agreement (SLA)). Further, based on local policies, authentication credentials evaluation, and an authentication result, the L-RMS may determine to deny a required access role requested by the end-device. The smart contracts can be used by the registry services described in these implementations to keep track of lifetime related expirations, linking of all DID related entries, and etc.

With reference to de-registering and/or revoking registrations of DID operation (i.e., DID or SSI based identity and trust management) participants from a PDL platform, new PDL platform services 502 are implemented, such as a role-based registration management service and a DID operational participants registry service (also referred to herein as a ledger-identity and trust management participant registry service). An end-user, end device, client, or device application (i.e., related to different registered participants, such as identity holder, identity controller, VC issuer, ID verifier) can be deregistered from the identity and trust management framework of the PDL platform or DID operation(al) participants registry based on a combination of one or more conditions, such as (i) the registry service identifies that a role-based registration has expired based on the lifetime expiration; (ii) a smart contract configured by the registry service to notify the lifetime expiry of any registration related to a registration ID, and the registry service then invokes the deregistration or revocation of a registration; (iii) a governance monitors the lifetime of a registration and prompts the registry service to revoke the registration if the lifetime of a registration is about to expire; (iv) the governance identifies that the registered end-user has violated any operations based on local policy; and (v) the L-RMS identifies that the registered end-user has violated any operations, or operates or performs contrary based on local policy.

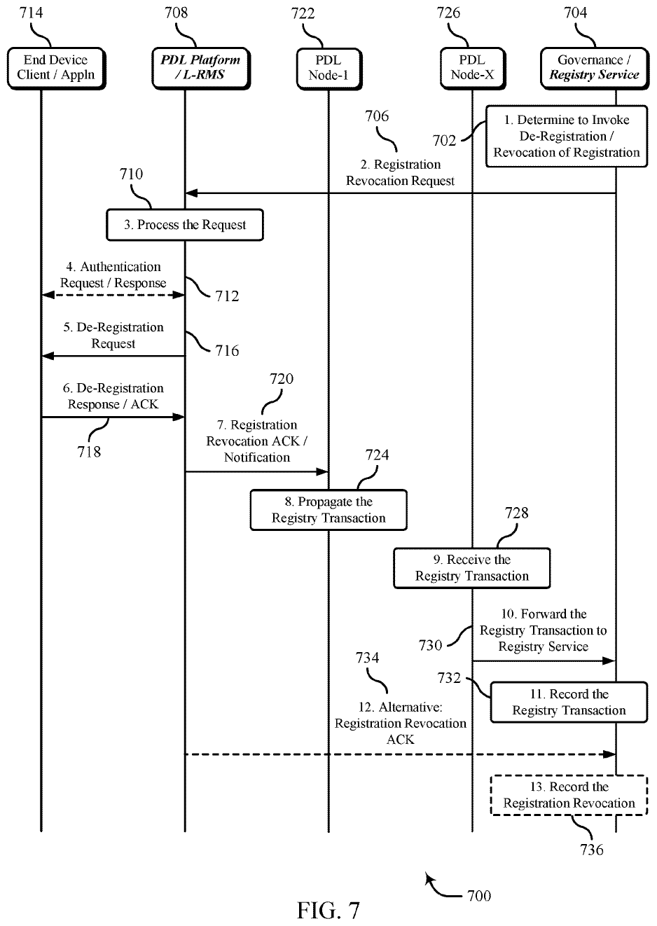

FIG. 7 illustrates an example diagram 700 of a revocation and de-registration procedure for the role-based registration, which supports registration handling of ledger-based identity in accordance with aspects of the present disclosure. This example diagram 700 illustrates the revocation of role-based registration (i.e., related to the registered participants), as described in the procedure steps below.

At a first step 702, a governance and/or registry service 704 may determine to revoke the registration for a registered participant (which may also consider the lifetime of the registration). In implementations, the registry service may also be referred to as a DID operation participants registry service, or a DID operation participants registration revocation service. At a second step 706, the registry service 704 sends to the L-RMS 708, the registration revocation request related to the end-user or end device registration based on the L-RMS ID associated for the registration ID related to the DID operation(al) participant registry transaction/information. Alternatively, the registration revocation request can be termed as a deregistration request, as referred to herein. The registration revocation request can include a L-RMS ID, a source identity, a registry service type and/or ID, a registration ID, an authorized access role, and a cause value related to the determination of the registration revocation (e.g., a lifetime expiry, an error, or any operational violation reason code).

At a third step 710, the L-RMS on receiving the registration revocation request for any registered participant associated with its L-RMS ID, the L-RMS can process and invoke the registration revocation. At a fourth step 712, based on local policy, the L-RMS can perform mutual authentication with the end-device 714 to authenticate and set up a secure connection. At a fifth step 716, the L-RMS can send to the end-device, a registration revocation notification message, which can include the source identity, service type information (DID service), a registration ID, and a cause value and/or information. At a sixth step 718, the end-device 714 can send to the L-RMS, the registration revocation acknowledgement (Ack) message (in response to the fifth step 716), which includes a registration ID and a success indication. Further the end-device 714 can delete all information associated to the registration, such as the registration ID, authorization information, etc.).

At a seventh step 720, the L-RMS can generate a registration revocation acknowledgement message and covert it to a transaction (i.e., registration revocation notification and acknowledgement) and sends (e.g., communicates, transmits) to a PDL node-1 722 based on the local configuration. The registration revocation notification can include the information related to the registry transaction, such as a registry service type and/or ID, a L-RMS ID, a source identity, service type information (DID service), a registration ID, and a revoked indication (or revocation successful indication).

At an eighth step 724, the PDL node-1 722 propagates the received transaction through the target PDL network to any PDL node-X 726. At a ninth step 728, the PDL node-X 726 (e.g., any PDL node-2) receives the transaction from the target PDL network as the result of transaction propagation. At a tenth step 730, after the transaction is validated and it is successfully stored to the ledger (e.g., as a result of PDL consensus process in a ledge related to the registry service associated to the DID operation(al) participant (revocation) registry (transaction) based on the target registry service type information), the PDL node-2 forwards the transaction to the registry service based on the target registry service information. The registry service transforms the transaction into a message to recover the message (i.e., registration revocation acknowledgement message). Alternatively, the PDL node-2 transforms the transaction into a message and sends the registration revocation notification and acknowledgement transaction as a registration revocation acknowledgement message to the registry service.

At an eleventh step 732, the registry service can store the registration revocation notification and acknowledgement transaction and/or information received as part of the registration revocation acknowledgement message (or vice versa) in the local storage, off-chain, and/or ledger. Smart contracts can be configured to link and maintain the registration status (such as successful registration and revocations) related to a registration ID and a source ID.

In implementations, alternative steps (either 7-11 or 12-13 can be implemented). At a twelfth step 734, based on local policy, the L-RMS can send to the configured registry service (in response to steps two and six), a registration revocation acknowledgment message, which includes a L-RMS ID, a source identity, a registry service type and ID, a registration ID, and a revoked indication (i.e., a successful revocation indication). At a thirteenth step 736, the registry service can store the information received in the registration revocation acknowledgment message in the local storage, off-chain, and/or ledger. Irrespective of the roles, any end-device or device application related to an ID holder, identity controller, VC issuer, and/or ID verifier, associated registration can be revoked using the procedure described in the example diagram 700 by providing the corresponding access role information in the second step 706. Further, the smart contracts can be used by the registry services described in this example to keep track of lifetime related expirations, the linking of all DID related entries, and etc.

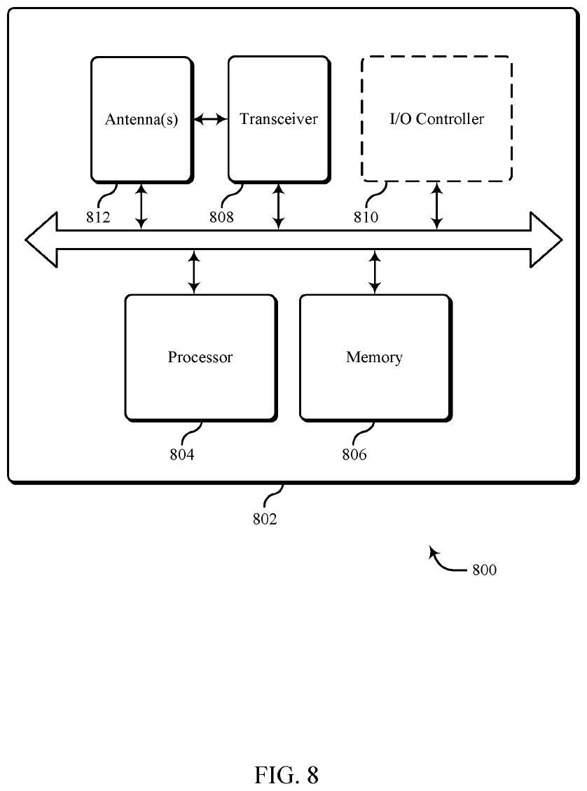

FIG. 8 illustrates an example of a block diagram 800 of a device 802 that supports registration handling of ledger-based identity in accordance with aspects of the present disclosure. The device 802 may be an example of a network entity 102, such as a device that implements L-RMS, or as a device that implements a registry service, as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for receiving a first signaling as a registration request from an end device; generating a registry notification message based at least in part on successful authentication of the end device; transmitting a second signaling as a registry transaction notification to a first network entity that implements a PDL; receiving a third signaling as a registration acknowledgement message from a second network entity that implements a registry service; and transmitting a fourth signaling as a registration response to the end device.

Additionally, the processor 804 may be configured as or otherwise support any one or combination of the registration request includes an indication of the end device as at least one of a source identity, service-type information, a DID, a required access role, or a requested access role. At least one of the required access role or the requested access role is indicated as a DID holder if the end device or an application of the end device belongs to the DID holder. At least one of the required access role or the requested access role is indicated as a DID controller if the end device or an application of the end device belongs to the DID controller. At least one of the required access role or the requested access role is indicated as a VC issuer if the end device or an application of the end device belongs to the VC issuer. At least one of the required access role or the requested access role is indicated as a DID verifier if the end device or an application of the end device belongs to the DID verifier. The registry notification message includes at least one of a L-RMS identifier, a source identifier, service type information, a registry service type, a registry service identifier, a registration identifier, a DID, authorization information, an authorized access role, or a lifetime expiration. The registration response includes an indication of a failure result based at least in part on an authentication failure, a requested access role cannot be accepted, or a local policy. The registration response includes at least one of an indication of a success result, a L-RMS identifier, service-type information, a registration identifier, an authorized access role, authorization information, or a lifetime expiration. The authorization information included in the registration response indicates a code or a token. The service-type information included in the registration response indicates a DID service offered by an identity and trust management framework. The method further comprising setting the registration identifier, setting the authorization information, and assigning the lifetime expiration for registration. The method further comprising generating the registry transaction notification based at least in part on an adaption transformation of the registry notification message. The registry transaction notification includes at least one of a L-RMS identifier, a source identifier, service-type information, a registry service type, a registry service identifier, a registration identifier, a DID, an authorized access role, authorization information, or a lifetime expiration. The registration acknowledgement message includes at least one of a L-RMS identifier, a source identifier, a registration identifier, a registry service type, a registry service identifier, or a success indication. The registration acknowledgement message is received from a DID operational participant registry service.

Additionally, or alternatively, the device 802, in accordance with examples as disclosed herein, may include a processor and a memory coupled with the processor, the processor configured to receive a first signaling as a registration request from an end device; generate a registry notification message based at least in part on successful authentication of the end device; transmit a second signaling as a registry transaction notification to a first network entity that implements a PDL; receive a third signaling as a registration acknowledgement message from a second network entity that implements a registry service; and transmit a fourth signaling as a registration response to the end device.

Additionally, the wireless communication at the device 802 may include any one or combination of the registration request includes an indication of the end device as at least one of a source identity, service-type information, a DID, a required access role, or a requested access role. At least one of the required access role or the requested access role is indicated as a DID holder if the end device or an application of the end device belongs to the DID holder. At least one of the required access role or the requested access role is indicated as a DID controller if the end device or an application of the end device belongs to the DID controller. At least one of the required access role or the requested access role is indicated as a VC issuer if the end device or an application of the end device belongs to the VC issuer. At least one of the required access role or the requested access role is indicated as a DID verifier if the end device or an application of the end device belongs to the DID verifier. The registry notification message includes at least one of a L-RMS identifier, a source identifier, service type information, a registry service type, a registry service identifier, a registration identifier, a DID, authorization information, an authorized access role, or a lifetime expiration. The registration response includes an indication of a failure result based at least in part on an authentication failure, a requested access role cannot be accepted, or a local policy. The registration response includes at least one of an indication of a success result, a L-RMS identifier, service-type information, a registration identifier, an authorized access role, authorization information, or a lifetime expiration. The authorization information included in the registration response indicates a code or a token. The service-type information included in the registration response indicates a DID service offered by an identity and trust management framework. The memory coupled with the processor is configured to set the registration identifier, set the authorization information, and assign the lifetime expiration for registration. The memory coupled with the processor is configured to generate the registry transaction notification based at least in part on an adaption transformation of the registry notification message. The registry transaction notification includes at least one of a L-RMS identifier, a source identifier, service-type information, a registry service type, a registry service identifier, a registration identifier, a DID, an authorized access role, authorization information, or a lifetime expiration. The registration acknowledgement message includes at least one of a L-RMS identifier, a source identifier, a registration identifier, a registry service type, a registry service identifier, or a success indication. The registration acknowledgement message is received from a DID operational participant registry service.

The processor 804 of the device 802, such as a UE 104, may support wireless communication in accordance with examples as disclosed herein. The processor 804 includes at least one controller coupled with at least one memory, and is configured to or operable to cause the processor to receive a first signaling as a registration request from an end device; generate a registry notification message based at least in part on successful authentication of the end device; transmit a second signaling as a registry transaction notification to a first network entity that implements a permissioned distributed ledger (PDL); receive a third signaling as a registration acknowledgement message from a second network entity that implements a registry service; and transmit a fourth signaling as a registration response to the end device.

In another example, the processor 804 may support wireless communication at the device 802 in accordance with examples as disclosed herein. The processor 804 may be configured as or otherwise support a means for receiving a first signaling as a registration revocation request associated with an end device, the registration revocation request received from a first network entity that implements a registry service; processing the registration revocation request based at least in part on a L-RMS identifier associated with the end device; and transmitting a second signaling as a registration revocation acknowledgement notification to the registry service that records registration revocation.

Additionally, the processor 804 may be configured as or otherwise support any one or combination of the second signaling is transmitted as the registration revocation acknowledgement notification to a second network entity that implements a PDL, the registration revocation acknowledgement notification propagated through a PDL network to the registry service that records the registration revocation. The method further comprising transmitting a third signaling as a registration revocation notification to the end device; and receiving a fourth signaling as a registration revocation acknowledgement message from the end device. The registration revocation request includes a L-RMS identifier associated with a registration identifier of a DID operational participant registry transaction corresponding to the end device. The registration revocation request includes at least one of a L-RMS identifier, a source identity, a registry service type, a registry service identifier, a registration identifier, or an authorized access role and a cause value related to the registration revocation. The registration revocation acknowledgement notification includes registry transaction information as at least one of a registry service type, a registry service identifier, a L-RMS identifier, a source identity, service type information, a registration identifier, or a revocation success indication.

Additionally, or alternatively, the device 802, in accordance with examples as disclosed herein, may include a processor and a memory coupled with the processor, the processor configured to receive a first signaling as a registration revocation request associated with an end device, the registration revocation request received from a first network entity that implements a registry service; process the registration revocation request based at least in part on a L-RMS identifier associated with the end device; and transmit a second signaling as a registration revocation acknowledgement notification to the registry service that records registration revocation.

Additionally, the wireless communication at the device 802 may include any one or combination of the second signaling is transmitted as the registration revocation acknowledgement notification to a second network entity that implements a PDL, the registration revocation acknowledgement notification propagated through a PDL network to the registry service that records the registration revocation. The memory coupled with the processor is configured to: transmit a third signaling as a registration revocation notification to the end device; and receive a fourth signaling as a registration revocation acknowledgement message from the end device. The registration revocation request includes a L-RMS identifier associated with a registration identifier of a DID operational participant registry transaction corresponding to the end device. The registration revocation request includes at least one of a L-RMS identifier, a source identity, a registry service type, a registry service identifier, a registration identifier, or an authorized access role and a cause value related to the registration revocation. The registration revocation acknowledgement notification includes registry transaction information as at least one of a registry service type, a registry service identifier, a L-RMS identifier, a source identity, service type information, a registration identifier, or a revocation success indication.

In another example, the processor 804 may support wireless communication at the device 802 in accordance with examples as disclosed herein. The processor 804 may be configured as or otherwise support a means for receiving a first signaling as a registry transaction notification from a PDL, the registry transaction notification generated by a L-RMS based at least in part on a registration request from an end device and successful authentication of the end device; recording the registry transaction notification; and transmitting a second signaling as a registration acknowledgement message to the L-RMS that communicates a registration response to the end device.

Additionally, the processor 804 may be configured as or otherwise support any one or combination of the registry transaction notification includes at least one of a L-RMS identifier, a source identifier, service-type information, a registry service type, a registry service identifier, a registration identifier, a DID, an authorized access role, authorization information, or a lifetime expiration. The registration acknowledgement message includes at least one of a L-RMS identifier, a source identifier, a registration identifier, a registry service type, a registry service identifier, or a success indication. The method further comprising maintaining records of DID based identity system participants, identified as at least one of a DID operational participant registry service, or a ledger-identity and trust management participant registry service. The method further comprising transmitting a third signaling as a registration revocation request to the L-RMS, the registration revocation request associated with the end device and based at least in part on a determination to invoke registration revocation. The method further comprising receiving a fourth signaling as a registry transaction revocation notification from the PDL, the registry transaction revocation notification routed from the L-RMS via the PDL; and recording the registry transaction revocation notification. The method further comprising receiving a fourth signaling as a registration revocation acknowledgement notification from the L-RMS; and recording the registration revocation acknowledgement notification.

Additionally, or alternatively, the device 802, in accordance with examples as disclosed herein, may include a processor and a memory coupled with the processor, the processor configured to receive a first signaling as a registry transaction notification from a PDL, the registry transaction notification generated by a L-RMS based at least in part on a registration request from an end device and successful authentication of the end device; record the registry transaction notification; and transmit a second signaling as a registration acknowledgement message to the L-RMS that communicates a registration response to the end device.

Additionally, the wireless communication at the device 802 may include any one or combination of the registry transaction notification includes at least one of a L-RMS identifier, a source identifier, service-type information, a registry service type, a registry service identifier, a registration identifier, a DID, an authorized access role, authorization information, or a lifetime expiration. The registration acknowledgement message includes at least one of a L-RMS identifier, a source identifier, a registration identifier, a registry service type, a registry service identifier, or a success indication. The memory coupled with the processor is configured to maintain records of DID based identity system participants, and the apparatus is identified as at least one of a DID operational participant registry service, or a ledger-identity and trust management participant registry service. The memory coupled with the processor is configured to transmit a third signaling as a registration revocation request to the L-RMS, the registration revocation request associated with the end device and based at least in part on a determination to invoke registration revocation. The memory coupled with the processor is configured to: receive a fourth signaling as a registry transaction revocation notification from the PDL, the registry transaction revocation notification routed from the L-RMS via the PDL; and record the registry transaction revocation notification. The memory coupled with the processor is configured to: receive a fourth signaling as a registration revocation acknowledgement notification from the L-RMS; and record the registration revocation acknowledgement notification.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

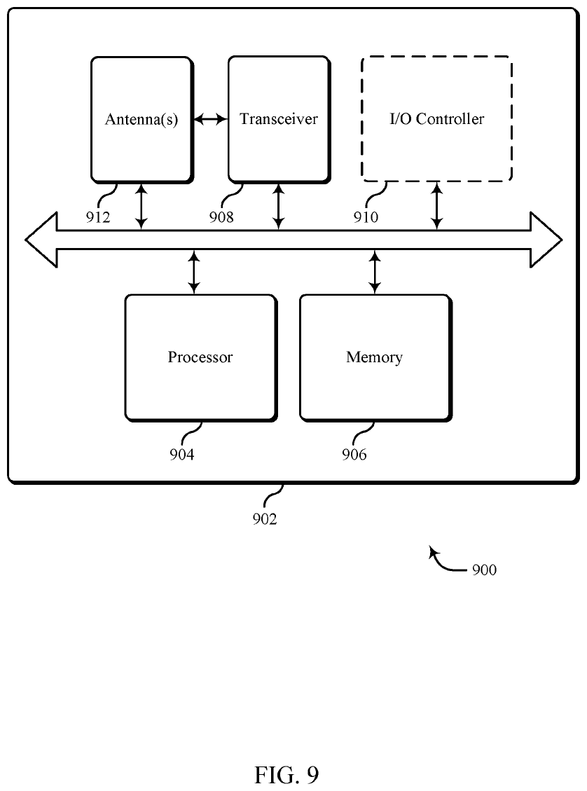

FIG. 9 illustrates an example of a block diagram 900 of a device 902 that supports registration handling of ledger-based identity in accordance with aspects of the present disclosure. The device 902 may be an example of a network entity 102, such as an end device or a device application, as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. The processor 904 may be configured as or otherwise support a means for transmitting a first signaling as a registration request for an end device to a first network entity that implements a L-RMS, the L-RMS authenticates the end device, transmits a registry transaction notification to a PDL, and receives a registration acknowledgement message from a registry service; and receiving a second signaling as a registration response from the L-RMS.

Additionally, the processor 904 may be configured as or otherwise support any one or combination of the registration request includes an indication of the end device as at least one of a source identity, service-type information, a DID, a required access role, or a requested access role. At least one of the required access role or the requested access role is indicated as a DID holder if the end device or an application of the end device belongs to the DID holder. At least one of the required access role or the requested access role is indicated as a DID controller if the end device or an application of the end device belongs to the DID controller. At least one of the required access role or the requested access role is indicated as a VC issuer if the end device or an application of the end device belongs to the VC issuer. At least one of the required access role or the requested access role is indicated as a DID verifier if the end device or an application of the end device belongs to the DID verifier. The registration response includes an indication of a failure result based at least in part on an authentication failure, a requested access role cannot be accepted, or a local policy. The registration response includes at least one of an indication of a success result, a L-RMS identifier, service-type information, a registration identifier, an authorized access role, authorization information, or a lifetime expiration. The authorization information included in the registration response indicates a code or a token. The service-type information included in the registration response indicates a DID service offered by an identity and trust management framework.

Additionally, or alternatively, the device 902, in accordance with examples as disclosed herein, may include a processor and a memory coupled with the processor, the processor configured to transmit a first signaling as a registration request to a first network entity that implements a L-RMS, which authenticates the apparatus, transmits a registry transaction notification to a PDL, and receives a registration acknowledgement message from a registry service; and receive a second signaling as a registration response from the L-RMS.

Additionally, the wireless communication at the device 902 may include any one or combination of the registration request includes an indication of the apparatus as at least one of a source identity, service-type information, a DID, a required access role, or a requested access role. At least one of the required access role or the requested access role is indicated as a DID holder if the apparatus or an application of the apparatus belongs to the DID holder. At least one of the required access role or the requested access role is indicated as a DID controller if the apparatus or an application of the apparatus belongs to the DID controller. At least one of the required access role or the requested access role is indicated as a VC issuer if the apparatus or an application of the apparatus belongs to the VC issuer. At least one of the required access role or the requested access role is indicated as a DID verifier if the apparatus or an application of the apparatus belongs to the DID verifier. The registration response includes an indication of a failure result based at least in part on an authentication failure, a requested access role cannot be accepted, or a local policy. The registration response includes at least one of an indication of a success result, a L-RMS identifier, service-type information, a registration identifier, an authorized access role, authorization information, or a lifetime expiration. The authorization information included in the registration response indicates a code or a token. The service-type information included in the registration response indicates a DID service offered by an identity and trust management framework.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

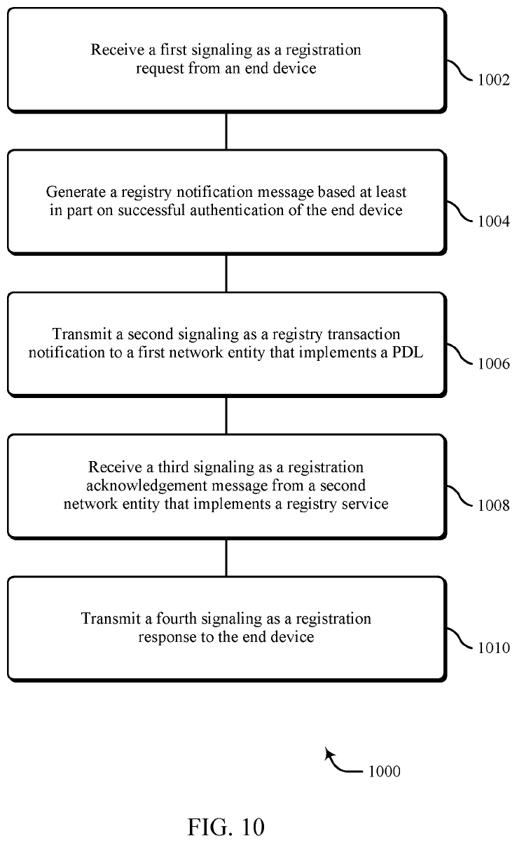

FIG. 10 illustrates a flowchart of a method 1000 that supports registration handling of ledger-based identity in accordance with aspects of the present disclosure. The operations of the method 1000 may be implemented by a device or its components as described herein. For example, the operations of the method 1000 may be performed by a network entity 102, such as a device that implements L-RMS as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include receiving a first signaling as a registration request from an end device. The operations of 1002 may be performed in accordance with examples as described herein. In some implementations, aspects of the operations of 1002 may be performed by a device as described with reference to FIG. 1.

At 1004, the method may include generating a registry notification message based at least in part on successful authentication of the end device. The operations of 1004 may be performed in accordance with examples as described herein. In some implementations, aspects of the operations of 1004 may be performed by a device as described with reference to FIG. 1.

At 1006, the method may include transmitting a second signaling as a registry transaction notification to a first network entity that implements a PDL. The operations of 1006 may be performed in accordance with examples as described herein. In some implementations, aspects of the operations of 1006 may be performed by a device as described with reference to FIG. 1.

At 1008, the method may include receiving a third signaling as a registration acknowledgement message from a second network entity that implements a registry service. The operations of 1008 may be performed in accordance with examples as described herein. In some implementations, aspects of the operations of 1008 may be performed by a device as described with reference to FIG. 1.

At 1010, the method may include transmitting a fourth signaling as a registration response to the end device. The operations of 1010 may be performed in accordance with examples as described herein. In some implementations, aspects of the operations of 1010 may be performed by a device as described with reference to FIG. 1.

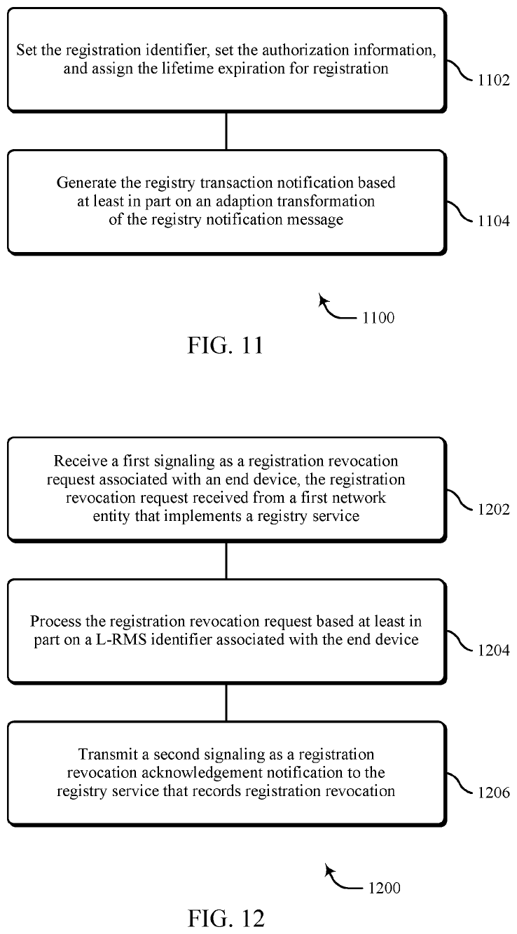

FIG. 11 illustrates a flowchart of a method 1100 that supports registration handling of ledger-based identity in accordance with aspects of the present disclosure. The operations of the method 1100 may be implemented by a device or its components as described herein. For example, the operations of the method 1100 may be performed by a network entity 102, such as a device that implements L-RMS as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include setting the registration identifier, setting the authorization information, and assigning the lifetime expiration for registration. The operations of 1102 may be performed in accordance with examples as described herein. In some implementations, aspects of the operations of 1102 may be performed by a device as described with reference to FIG. 1.

At 1104, the method may include generating the registry transaction notification based at least in part on an adaption transformation of the registry notification message. The operations of 1104 may be performed in accordance with examples as described herein. In some implementations, aspects of the operations of 1104 may be performed by a device as described with reference to FIG. 1.

FIG. 12 illustrates a flowchart of a method 1200 that supports registration handling of ledger-based identity in accordance with aspects of the present disclosure. The operations of the method 1200 may be implemented by a device or its components as described herein. For example, the operations of the method 1200 may be performed by a network entity 102, such as a device that implements L-RMS as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include receiving a first signaling as a registration revocation request associated with an end device, the registration revocation request received from a first network entity that implements a registry service. The operations of 1202 may be performed in accordance with examples as described herein. In some implementations, aspects of the operations of 1202 may be performed by a device as described with reference to FIG. 1.

At 1204, the method may include processing the registration revocation request based at least in part on a L-RMS identifier associated with the end device. The operations of 1204 may be performed in accordance with examples as described herein. In some implementations, aspects of the operations of 1204 may be performed by a device as described with reference to FIG. 1.

At 1206, the method may include transmitting a second signaling as a registration revocation acknowledgement notification to the registry service that records registration revocation. The operations of 1206 may be performed in accordance with examples as described herein. In some implementations, aspects of the operations of 1206 may be performed by a device as described with reference to FIG. 1.

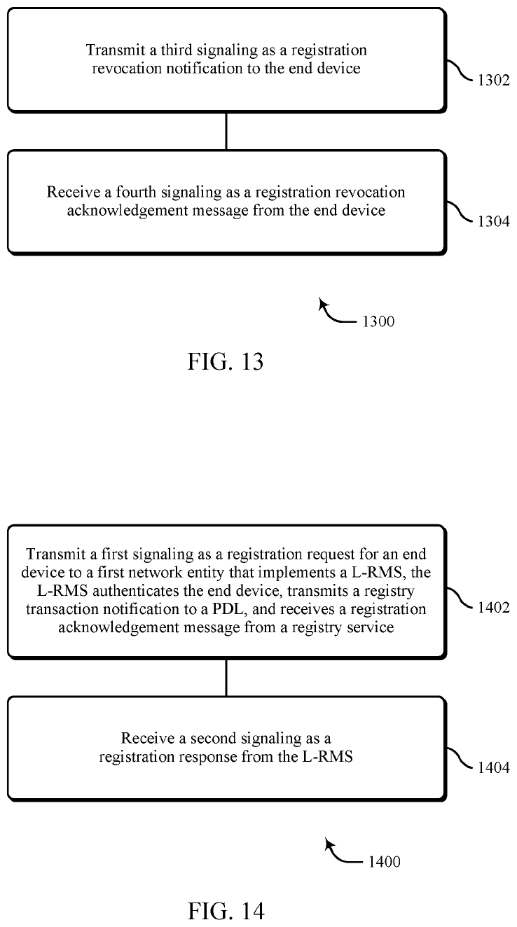

FIG. 13 illustrates a flowchart of a method 1300 that supports registration handling of ledger-based identity in accordance with aspects of the present disclosure. The operations of the method 1300 may be implemented by a device or its components as described herein. For example, the operations of the method 1300 may be performed by a network entity 102, such as a device that implements L-RMS as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1302, the method may include transmitting a third signaling as a registration revocation notification to the end device. The operations of 1302 may be performed in accordance with examples as described herein. In some implementations, aspects of the operations of 1302 may be performed by a device as described with reference to FIG. 1.

At 1304, the method may include receiving a fourth signaling as a registration revocation acknowledgement message from the end device. The operations of 1304 may be performed in accordance with examples as described herein. In some implementations, aspects of the operations of 1304 may be performed by a device as described with reference to FIG. 1.

FIG. 14 illustrates a flowchart of a method 1400 that supports registration handling of ledger-based identity in accordance with aspects of the present disclosure. The operations of the method 1400 may be implemented by a device or its components as described herein. For example, the operations of the method 1400 may be performed by a network entity 102, such as an end device or a device application as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1402, the method may include transmitting a first signaling as a registration request for an end device to a first network entity that implements a L-RMS, the L-RMS authenticates the end device, transmits a registry transaction notification to a PDL, and receives a registration acknowledgement message from a registry service. The operations of 1402 may be performed in accordance with examples as described herein. In some implementations, aspects of the operations of 1402 may be performed by a device as described with reference to FIG. 1.

At 1404, the method may include receiving a second signaling as a registration response from the L-RMS. The operations of 1404 may be performed in accordance with examples as described herein. In some implementations, aspects of the operations of 1404 may be performed by a device as described with reference to FIG. 1.

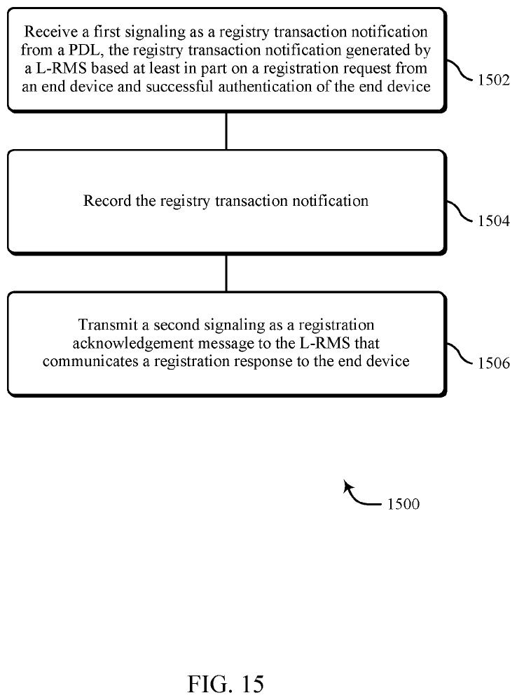

FIG. 15 illustrates a flowchart of a method 1500 that supports registration handling of ledger-based identity in accordance with aspects of the present disclosure. The operations of the method 1500 may be implemented by a device or its components as described herein. For example, the operations of the method 1500 may be performed by a network entity 102, such as a device that implements a registry service as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1502, the method may include receiving a first signaling as a registry transaction notification from a PDL, the registry transaction notification generated by a L-RMS based at least in part on a registration request from an end device and successful authentication of the end device.

The operations of 1502 may be performed in accordance with examples as described herein. In some implementations, aspects of the operations of 1502 may be performed by a device as described with reference to FIG. 1.

At 1504, the method may include recording the registry transaction notification. The operations of 1504 may be performed in accordance with examples as described herein. In some implementations, aspects of the operations of 1504 may be performed by a device as described with reference to FIG. 1.

At 1506, the method may include transmitting a second signaling as a registration acknowledgement message to the L-RMS that communicates a registration response to the end device. The operations of 1506 may be performed in accordance with examples as described herein. In some implementations, aspects of the operations of 1506 may be performed by a device as described with reference to FIG. 1.

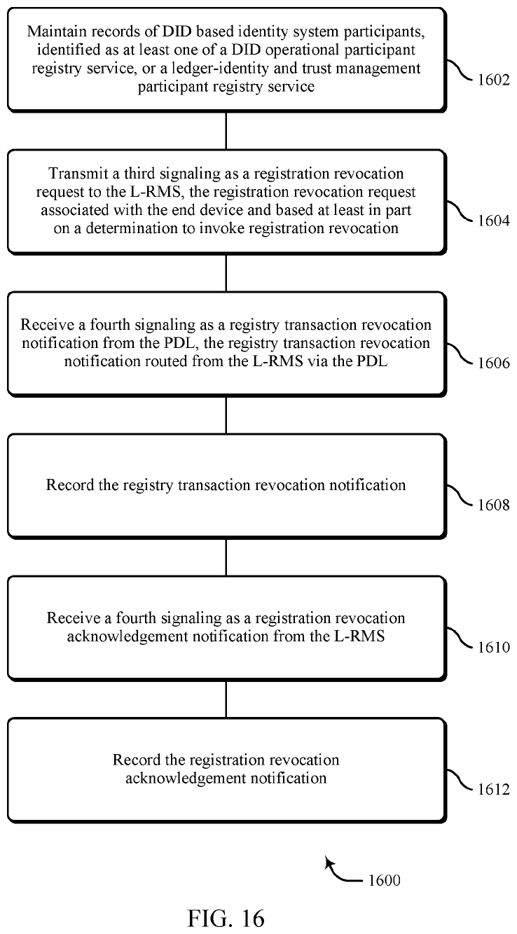

FIG. 16 illustrates a flowchart of a method 1600 that supports registration handling of ledger-based identity in accordance with aspects of the present disclosure. The operations of the method 1600 may be implemented by a device or its components as described herein. For example, the operations of the method 1600 may be performed by a network entity 102, such as a device that implements a registry service as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1602, the method may include maintaining records of DID based identity system participants, identified as at least one of a DID operational participant registry service, or a ledger-identity and trust management participant registry service. The operations of 1602 may be performed in accordance with examples as described herein. In some implementations, aspects of the operations of 1602 may be performed by a device as described with reference to FIG. 1.

At 1604, the method may include transmitting a third signaling as a registration revocation request to the L-RMS, the registration revocation request associated with the end device and based at least in part on a determination to invoke registration revocation. The operations of 1604 may be performed in accordance with examples as described herein. In some implementations, aspects of the operations of 1604 may be performed by a device as described with reference to FIG. 1.

At 1606, the method may include receiving a fourth signaling as a registry transaction revocation notification from the PDL, the registry transaction revocation notification routed from the L-RMS via the PDL. The operations of 1606 may be performed in accordance with examples as described herein. In some implementations, aspects of the operations of 1606 may be performed by a device as described with reference to FIG. 1.

At 1608, the method may include recording the registry transaction revocation notification. The operations of 1608 may be performed in accordance with examples as described herein. In some implementations, aspects of the operations of 1608 may be performed by a device as described with reference to FIG. 1.

At 1610, the method may include receiving a fourth signaling as a registration revocation acknowledgement notification from the L-RMS. The operations of 1610 may be performed in accordance with examples as described herein. In some implementations, aspects of the operations of 1610 may be performed by a device as described with reference to FIG. 1.

At 1612, the method may include recording the registration revocation acknowledgement notification. The operations of 1612 may be performed in accordance with examples as described herein. In some implementations, aspects of the operations of 1612 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and operable to cause the apparatus to:
receive, from a user equipment (UE), a registration request;
generate a registry notification message based at least in part on successful authentication of the UE;
transmit, to a first network entity, a registry transaction notification for a permissioned distributed ledger (PDL);
receive, from a second network entity, a registration acknowledgement message for a registry service; and
transmit, to the UE, registration response.

2. The apparatus of claim 1, wherein the registration request includes an indication of the UE as at least one of a source identity, service-type information, a decentralized identifier (DID), a required access role, or a requested access role.

3. The apparatus of claim 2, wherein at least one of the required access role or the requested access role is indicated as at least one of a DID holder if the UE or an application of the UE belongs to the DID holder or an identity holder, or a DID controller if the UE or the application of the UE belongs to the DID controller or an identity controller.

4. The apparatus of claim 2, wherein at least one of the required access role or the requested access role is indicated as at least one of a verifiable credential (VC) issuer if the UE or an application of the UE belongs to the VC issuer, or a DID verifier if the UE or the application of the UE belongs to the DID verifier.

5. The apparatus of claim 1, wherein the registry notification message includes at least one of a ledger registration management service (L-RMS) identifier, a source identifier, service type information, a registry service type, a registry service identifier, a registration identifier, a decentralized identifier (DID), authorization information, an authorized access role, or a lifetime expiration.

6. The apparatus of claim 1, wherein the registration response includes an indication of a failure result based at least in part on an authentication failure, a requested access role cannot be accepted, or a local policy.

7. The apparatus of claim 1, wherein the registration response includes at least one of an indication of a success result, a ledger registration management service (L-RMS) identifier, service-type information, a registration identifier, an authorized access role, authorization information, or a lifetime expiration.

8. The apparatus of claim 7, wherein the at least one processor is operable to cause the apparatus to set the registration identifier, set the authorization information, and assign the lifetime expiration for registration.

9. The apparatus of claim 1, wherein the at least one processor is operable to cause the apparatus to generate the registry transaction notification based at least in part on an adaption transformation of the registry notification message.

10. The apparatus of claim 1, wherein the registration acknowledgement message includes at least one of a ledger registration management service (L-RMS) identifier, a source identifier, a registration identifier, a registry service type, a registry service identifier, or a success indication.

11. An apparatus for wireless communication, comprising:
at least one memory; and
at least one processor coupled with the at least one memory and operable to cause the apparatus to:
transmit a registration request to a network entity that implements a ledger registration management service (L-RMS), which authenticates the apparatus, transmits a registry transaction notification to a permissioned distributed ledger (PDL) node or network, and receives a registration acknowledgement message from a registry service; and
receive a registration response from the L-RMS.

12. An apparatus for wireless communication, comprising:
at least one memory; and
at least one processor coupled with the at least one memory and operable to cause the apparatus to:
receive, from a first network entity, a registration revocation request associated with a user equipment (UE), the registration revocation request for a registry service;
process the registration revocation request based at least in part on a ledger registration management service (L-RMS) identifier associated with the UE; and
transmit a registration revocation acknowledgement notification to the registry service that records registration revocation.

13. The apparatus of claim 12, wherein the registration revocation acknowledgement notification is transmitted to a second network entity as a permissioned distributed ledger (PDL) node or network, the registration revocation acknowledgement notification propagated through a PDL network to the registry service that records the registration revocation.

14. The apparatus of claim 12, wherein the at least one processor is operable to cause the apparatus to:
transmit, to the UE, a registration revocation notification or a deregistration notification and
receive, from the UE, a registration revocation acknowledgement message or a deregistration acknowledgement message.

15. The apparatus of claim 12, wherein the registration revocation request includes a L-RMS identifier associated with a registration identifier of a decentralized identifier (DID) operational participant registry information transaction corresponding to the UE.

16. The apparatus of claim 12, wherein the registration revocation request includes at least one of a L-RMS identifier, a source identity, a registry service type, a registry service identifier, a registration identifier, or an authorized access role and a cause value related to the registration revocation.

17. The apparatus of claim 12, wherein the registration revocation acknowledgement notification includes registry transaction information as at least one of a registry service type, a registry service identifier, a L-RMS identifier, a source identity, service type information, a registration identifier, or a revocation success indication.

18. An apparatus for wireless communication, comprising:
at least one memory; and
at least one processor coupled with the at least one memory and operable to cause the apparatus to:
receive, from a permissioned distributed ledger (PDL) node or network, a registry transaction notification generated by a ledger registration management service (L-RMS) based at least in part on a registration request from a user equipment (UE) and successful authentication of the UE;
record the registry transaction notification; and
transmit a second signaling as a registration acknowledgement message to the L-RMS that communicates a registration response to the UE.

19. The apparatus of claim 18, wherein the at least one processor is operable to cause the apparatus to transmit a registration revocation request to the L-RMS, the registration revocation request associated with the UE and based at least in part on a determination to invoke registration revocation or deregistration.

20. The apparatus of claim 19, wherein the at least one processor is operable to cause the apparatus to receive at least one of:
a registry transaction revocation notification from the PDL node or network, the registry transaction revocation notification routed from the L-RMS via the PDL node or network, and record the registry transaction revocation notification; or
a registration revocation acknowledgement notification from the L-RMS, and record the registration revocation acknowledgement notification.
